(19) United States
(12) Patent Application Publication
(10) Pub. No.: US 2025/0192993 A1
(43) Pub. Date: Jun. 12, 2025

(54) KEY DELIVERY SYSTEM, KEY DELIVERY METHOD, AND PROGRAM

(71) Applicant: NEC Platforms, Ltd., Kawasaki-shi, Kanagawa (JP)

(72) Inventor: Ryo Uchiyama, Kanagawa (JP)

(73) Assignee: NEC Platforms, Ltd., Kawasaki-shi, Kanagawa (JP)

(21) Appl. No.: 18/846,400

(22) PCT Filed: Mar. 22, 2022
(86) PCT No.: PCT/JP2022/013313

§ 371 Date: Sep. 12, 2024

(51) Int. Cl. H04L 9/08; H04L 9/32

(52) U.S. Cl. CPC H04L 9/085; H04L 9/32

(57) ABSTRACT

A key delivery system, includes: a key issuance apparatus generating and issuing an encryption key; a distribution apparatus including: a share data generation part electronically dividing the encryption key into share data using a secret sharing scheme, a transmission destination verification part verifying validity of a transmission destination in transmitting the share data, and a share data transmission part transmitting the share data to the transmission destination, when a verification result obtained by the transmission destination verification part is valid; and a decryption apparatus including: a transmission source verification part verifying validity of a transmission source, in receiving the share data, a share data reception part receiving the share data from the transmission source when a verification result obtained by the transmission source verification part is valid, and a decryption part decrypting the encryption key using the share data received, as an input value.

### TECHNICAL FIELD

The present invention relates to a key delivery system, a key delivery method, and a program.

### BACKGROUND ART

Conventionally, when confidential data such as an authentication key is managed, the confidential data is stored in a tamper-resistant storage apparatus so that the confidential data will not be analyzed by malicious third parties (hereinafter referred to as attackers). In particular, an apparatus for key management is referred to as a key management system (KMS). The KMS has centralized features and is uniquely implemented by a vendor as a server-client model. Recent years have seen progress on standardization of the KMS by a key management system vendor and a standards organization called OASIS.

In recent years, from a viewpoint of business continuity, there is a growing need for distributed backup management at a plurality of sites. However, a conventional key management system is not targeted for distributed management. In addition, managing an encryption key requiring confidentiality in a distributed manner is based on the premise that the security measures have been sufficiently applied at the individual sites, and there has been indicated a risk for leakage of the secret information to attackers. As one of the effective techniques for reducing this risk, there is a secret sharing scheme.

### [Outline of Secret Sharing Scheme]

The secret sharing scheme is an encryption technique for electronically dividing target data into a plurality of data and creating a state in which the information about the original data cannot be obtained from one data alone. One example of the secret sharing scheme is a visual secret sharing scheme in which original image data is electronically divided into, for example, a plurality of image data, and the original data is restored by superimposing all the divided image data. Another example of the secret sharing scheme is an auditory secret sharing scheme in which original data is divided into a plurality of audio data, and the original data is restored by superimposing all the divided audio data.

The secret sharing scheme can be generally defined as follows. Distribution phase: A device D in charge of distribution converts distribution target encryption key data s into a number n of data, and distributes these converted data to other devices (the divided data obtained after this conversion will be referred to as share data). Decryption phase: Of all the n devices, a number k of devices participate in a decryption process, and a number k of share data of the k devices are provided, so as to restore the original encryption key data s.

In the simplest secret sharing scheme, the original data can be restored only when all the n share data generated in the distribution phase are collected (because k=n in the decryption phase, this scheme is referred to as a unanimous consent method). However, this unanimous consent method has a problem in that the original encryption key data s cannot be restored if any of the share data cannot be acquired from a device for some reason. As a protocol solving this problem, there is a (k, n) threshold secret sharing scheme (hereinafter referred to as a (k, n) threshold scheme).

### [Outline of (k, n) Threshold Secret Sharing Scheme]

The (k, n) threshold scheme is a secret sharing scheme that satisfies the following conditions.

1. If a number k of any share data is collected from a number n of share data, original data s can be restored.

2. With a number k−1 of share data or less, the original data s cannot be restored.

In this case, it is impossible to obtain any of the original data. Even fragmentary information about the original data cannot be obtained.

With the (k, n) threshold scheme, even if a number n-k of share data cannot be acquired, the original data can be restored from the remaining number k of share data. While there are a plurality of schemes that belong to the (k, n) threshold scheme, a representative scheme is Shamir's (k, n) threshold scheme of Non-Patent Literature (NPL) 1. First, an example of a (2, n) threshold scheme will be described, and next, Shamir's (k, n) threshold scheme will be described in detail.

### [(2, n) Threshold Secret Sharing Scheme]

As illustrated in FIG. 8, the (2, n) threshold scheme uses a theorem “With the coordinates of two independent points, a first-degree polynomial ax+b (a straight line) is uniquely determined”.

In the (2, n) threshold scheme, distribution and decryption are executed as follows.

### Distribution Phase:

1. A device D in charge of distribution creates a first-degree polynomial y=ax+s in which the distribution target encryption key data s is the intercept, and the coefficient a is randomly selected based on a random number.

2. The device D calculates the coordinates (i, f(x)) of the n points that go through the polynomial (i=1, . . . , n), and distributes these coordinates as share data.

### Decryption Phase:

1. At decryption, the device D collects the share data (coordinates) of two or more points distributed to the other devices, and calculates the original polynomial, so as to obtain the original encryption key data s. In the decryption phase, even if the device D acquires the share data of one point, because there are a countless number of first-degree straight lines going through this one point, the device D cannot obtain the original data s. In contrast, if the device D acquires the share data of two points, because a first-degree straight line going through these two points is uniquely determined, the device D can obtain the original key data s (=f(0)).

### [Proof of Polynomial Identity Theorem Used in (k, n) Threshold Scheme]

The theorem “With the coordinates of two independent points, a first-degree polynomial ax+b (a straight line) is uniquely determined” used in the (2, n) threshold scheme can be generalized as follows. This generalized theorem is used in Shamir's (k, n) threshold scheme of NPL 1, which will be described below.
With the coordinates of k+1 independent points, a kth-degree polynomial is uniquely determined.

The above is based on a polynomial identity theorem “for example, if there are two polynomials f and g of degree K or less and if, regarding k+1 real numbers a₁, a₂, . . . , and a₍ₖ₊₁₎, “f(a₁)=g(a₁), f(a₂)=g(a₂), . . . , and f(a₍ₖ₊₁₎)=g(a₍ₖ₊₁₎) is always true, f and g are the same polynomial”.

The polynomial identity theorem can be proven as follows. In the case of F(x)=f(x)−g(x), because f(a₁)=g(a₁), f(a₂)=g(a₂), . . . , and f(a₍ₖ₊₁₎)=g(a₍ₖ₊₁₎), equations F(a₁)=0, F(a₂)=0, . . . , and F(a₍ₖ₊₁₎)=0 are established. In addition, because F(a₁)=0, F(a₂)=0, . . . , and F(a₍ₖ₊₁₎)=0 are each a root of the polynomial, a value of F(x)=(x−a₁) (x−a₂) . . . (x−a₍ₖ₊₁₎)G(x) is obtained based on the factor theorem. Because F(x) is the difference between the polynomials f and g of degree K or less, F(x) itself is also a polynomial of degree K or less. In addition, because a product of (x−a₁) (x−a₂) . . . (x−a₍ₖ₊₁₎) is a (k+1)th-degree polynomial, G(x)=0 is established, no matter what value is assigned to a variable. As a result, because F(x)=(x−a₁) (x−a₂) . . . (x−a₍ₖ₊₁₎)G(x)=(x−a₁) (x−a₂) . . . (x−a₍ₖ₊₁₎)·0 is established, F(x)=0⇒f(x)=g(x) is established.

From this polynomial identity theorem, it is seen that, with a number k+1 of real numbers, the polynomial of degree K or less can be uniquely determined.

### [Shamir's (k, n) Threshold Secret Sharing Scheme]

Shamir's (k, n) threshold secret sharing scheme of NPL 1 (hereinafter referred to as (k, n) threshold scheme) uses the theorem “With the coordinates of k+1 independent points, a kth-degree polynomial is uniquely determined”.

In Shamir's (k, n) threshold secret sharing scheme, distribution and decryption are executed as follows.

### Distribution Phase:

1. A device D in charge of distribution selects a prime p greater than max (s, n) in which original key data is s and degree is n (p is not secret information but a preset shared parameter).

2. The device D in charge of distribution randomly selects a coefficient, and creates a kth-degree polynomial on GF(p) expressed by Equation 1 in which an intercept is the original key data s.

3. The device D in charge of distribution uses i=1, . . . n as IDs, calculates f(i) in which i is x (variable), and distributes (i, f(i)) to other devices.

4. The device D in charge of distribution discards parameters a₁ to aₖ of the kth-degree polynomial created in the above 2.

$$f ( x ) = ( s + {a}_{1} x + {a}_{2} {x}^{3} + … + {a}_{k} {x}^{k} ) mod p \qquad [ Equation 1 ]$$

### Restoration Phase:

1. A device acquires k+1 distributed coordinates (i, f(i)) from k+1 devices of the n devices.

2. The device restores the kth-degree polynomial created in the distribution phase.

When the device D executes this restoration, the device D uses Lagrange interpolation to calculate a value corresponding to f(0), that is, the original key data s.

With Shamir's (k, n) threshold scheme, security can be ensured in the following two senses. In one sense, it becomes unnecessary to rely on the security at a certain single site. Even if secret information at a single site is stolen, because this information is meaningless data, the risk for leakage of secret information can be reduced, and reliability in confidentiality can be improved. In the other sense, even if one item of distributed secret information is lost, because restoration can be executed by using other data, reliability in redundancy can be improved.

As similar (k, n) threshold schemes, there have been disclosed many (k, n) threshold schemes improved based on Shamir's (k, n) threshold scheme. For example, to strengthen the data security in the secret sharing scheme, there have been disclosed many improved techniques (verifiable secret sharing schemes) for verifying whether a distribution source and a distribution destination have created distribution information in a valid procedure.

### [Lagrange Interpolation]

In Shamir's (k, n) threshold scheme of NPL 1, when the original key data s alone is obtained, Lagrange interpolation (Lagrange's interpolation polynomial) is used. This is because the original key data s can be obtained more easily by Lagrange interpolation than by a simultaneous equation. In a simultaneous equation, a kth-degree polynomial f is first calculated from (k+1) coordinates, and f(0)=s is next calculated. However, in Lagrange interpolation, the intercept s can be directly calculated from (k+1) share data. A Lagrange interpolation formula can be derived as follows.

The real number coordinates at k+1 independent points are set as (a₁, f(a₁)), (a₂, f(a₂)), . . . , and (a₍ₖ₊₁₎, f(a₍ₖ₊₁₎)). Next, a polynomial p(x), which includes products and sums of polynomials of Lᵢ(x) and which is expressed by Equation 2, is established.

$$p ( x ) = f ( {a}_{1} ) {L}_{1} ( x ) + f ( {a}_{2} ) {L}_{2} ( x ) + … + f ( {a}_{( k + 1 )} ) {L}_{( k + 1 )} ( x ) \qquad [ Equation 2 ]$$

In this case, in order to establish p(x)=f(x) when x=a₁, Equation 3 needs to be satisfied.

$$When x = {a}_{1} , {L}_{1} ( {a}_{1} ) = 1 , {L}_{2} ( {a}_{1} ) = 0 , {L}_{3} ( {a}_{1} ) = 0 , {L}_{4} ( {a}_{1} ) = 0 , \\ … , and {L}_{( k + 1 )} ( {a}_{1} ) = 0 \qquad [ Equation 3 ]$$

In the same way, it is seen that, in order to always establish p(x)=f(x), all equations in Equation 4 need to be satisfied. This is because, if the above is satisfied, p(x)=f(x) is satisfied at the k+1 points of(a₁, f(a₁)), (a₂, f(a₂)), . . . , and (a₍ₖ₊₁₎, f(a₍ₖ₊₁₎)), and from the polynomial identity theorem, it is possible to indicate that p and f are the same polynomial.

$$[ Equation 4 ]$$

$$When x = {a}_{1} , {L}_{1} ( {a}_{1} ) = 1 , {L}_{2} ( {a}_{1} ) = 0 , {L}_{3} ( {a}_{1} ) = 0 , {L}_{4} ( {a}_{1} ) = 0 , \\ … , {L}_{( k )} ( {a}_{1} ) = 0 , and {L}_{( k + 1 )} ( {a}_{1} ) = 0$$

$$When x = {a}_{2} , {L}_{1} ( {a}_{2} ) = 0 , {L}_{2} ( {a}_{2} ) = 1 , {L}_{3} ( {a}_{2} ) = 0 , {L}_{4} ( {a}_{2} ) = 0 , … , \\ {L}_{( k )} ( {a}_{1} ) = 0 , and {L}_{( k + 1 )} ( {a}_{2} ) = 0$$

$$When x = {a}_{3} , {L}_{1} ( {a}_{3} ) = 0 , {L}_{2} ( {a}_{3} ) = 0 , {L}_{3} ( {a}_{3} ) = 1 , {L}_{4} ( {a}_{3} ) = 0 , … , \\ {L}_{( k )} ( {a}_{1} ) = 0 , and {L}_{( k + 1 )} ( {a}_{3} ) = 0$$

$$…$$

$$When x = {a}_{( k + 1 )} , {L}_{1} ( {a}_{( k + 1 )} ) = 0 , {L}_{2} ( {a}_{( k + 1 )} ) = 0 , {L}_{3} ( {a}_{( k + 1 )} ) = 0 , \\ {L}_{4} ( {a}_{( k + 1 )} ) = 0 , … , {L}_{( k )} ( {a}_{( k + 1 )} ) = 0 , and {L}_{( k + 1 )} ( {a}_{( k + 1 )} ) = 1$$

From the factor theorem, Equation 5 is obtained. In Equation 5, while d1, d2, d3, . . . , and d(k+1) are constants, because L₁(a₁)=1, L₂(a₂)=1, L₃(a₃)=1, . . . , and L₍ₖ₊₁₎(a₍ₖ₊₁₎)=1, Equation 6 can be obtained. Thus, a Lagrange interpolation formula of Equation 7 can be derived. In Shamir's (k, n) threshold scheme, values of each of the share data are first assigned to the Lagrange interpolation formula, and then f(0)=s is next calculated.

$${L}_{1} ( x ) = {d}_{1} ( x - {a}_{2} ) ( x - {a}_{3} ) … ( x - {a}_{k} ) ( x - {a}_{( k + 1 )} ) \qquad [ Equation 5 ]$$

$${L}_{2} ( x ) = {d}_{2} ( x - {a}_{1} ) ( x - {a}_{3} ) … ( x - {a}_{k} ) ( x - {a}_{( k + 1 )} )$$

$${L}_{3} ( x ) = {d}_{3} ( x - {a}_{1} ) ( x - {a}_{2} ) ( x - {a}_{4} ) … ( x - {a}_{k} ) ( x - {a}_{( k + 1 )} )$$

$$…$$

$${L}_{( k + 1 )} ( x ) = {d}_{( k + 1 )} ( x - {a}_{1} ) ( x - {a}_{2} ) ( x - {a}_{3} ) … ( x - {a}_{k} )$$

$${d}_{1} = 1 / ( ( {a}_{1} - {a}_{2} ) ( {a}_{1} - {a}_{3} ) … ( {a}_{1} - {a}_{k} ) ( ( {a}_{1} - {a}_{( k + 1 )} ) ) \qquad [ Equation 6 ]$$

$${d}_{2} = 1 / ( ( {a}_{2} - {a}_{1} ) ( {a}_{2} - {a}_{3} ) … ( {a}_{2} - {a}_{k} ) ( ( {a}_{2} - {a}_{( k + 1 )} ) )$$

$${d}_{3} = 1 / ( ( {a}_{3} - {a}_{1} ) ( {a}_{3} - {a}_{2} ) ( {a}_{3} - {a}_{4} ) … ( {a}_{3} - {a}_{k} ) ( ( {a}_{3} - {a}_{( k + 1 )} ) )$$

$$…$$

$${d}_{( k + 1 )} = 1 / ( ( {a}_{( k + 1 )} - {a}_{1} ) ( {a}_{( k + 1 )} - {a}_{2} ) ( {a}_{( k + 1 )} - {a}_{3} ) … ( {a}_{( k + 1 )} - {a}_{k} ) )$$

$$f ( x ) = ( x - {a}_{2} ) ( x - {a}_{3} ) … ( x - {a}_{k} ) ( x - {a}_{( k + 1 )} ) / ( ( {a}_{1} - {a}_{2} ) ( {a}_{1} - {a}_{3} ) … ( {a}_{1} - {a}_{k} ) ( {a}_{1} - {a}_{( k + 1 )} ) \times f ( {a}_{1} ) + ( x - {a}_{1} ) ( x - {a}_{3} ) … ( x - {a}_{k} ) ( x - {a}_{( k + 1 )} ) / ( ( {a}_{2} - {a}_{1} ) ( {a}_{2} - {a}_{3} ) … ( x - {a}_{k} ) ( x - {a}_{( k + 1 )} ) ) \times f ( {a}_{2} ) + ( x - {a}_{1} ) ( x - {a}_{2} ) ( x - {a}_{4} ) … ( x - {a}_{k} ) ( x - {a}_{( k + 1 )} ) / ( ( {a}_{3} - {a}_{1} ) ( {a}_{3} - {a}_{2} ) ( {a}_{3} - {a}_{4} ) … ( {a}_{3} - {a}_{k} ) ( {a}_{3} - {a}_{( k + 1 )} ) \times f ( {a}_{3} ) + … + ( x - {a}_{1} ) ( x - {a}_{2} ) ( x - {a}_{4} ) … ( x - {a}_{k} ) / ( ( {a}_{( k + 1 )} - {a}_{1} ) ( {a}_{( k + 1 )} - {a}_{2} ) ( {a}_{( k + 1 )} - {a}_{4} ) … ( {a}_{( k + 1 )} - {a}_{k} ) ) ⋆ f ( {a}_{( k + 1 )} ) \qquad [ Equation 7 ]$$

### [Finite Field]

The (k, n) secret sharing scheme has the following problems when actually implemented in a computer.

One problem is that, while the polynomial identity theorem and Lagrange interpolation are directed to real numbers, a computer on which the (k, n) secret sharing scheme is implemented cannot handle “infinite” numbers like real numbers. While it is necessary to use multiple-precision integers in order to handle a value close to infinity, an enormous calculation cost is needed. In addition, “uniform random numbers in an infinite space” cannot be generated on a computer, and biased random numbers in a range of finite values are generated.

Another problem is that, because division operations are executed in the (k, n) secret sharing scheme, floating-point errors could occur. Thus, consideration is needed in implementation such that all the operations are executed based on integer operations.

Shamir's (k, n) threshold scheme introduces a finite field GF(p) modulo a prime p greater than max (s, n). The finite field GF(p) is a system including only {0, 1, 2, . . . , p}, and is an algebraic system in which results obtained by four arithmetic operations are also represented by only {0, 1, 2, . . . , p}. Introducing the finite field GF(p) solves the problem with the calculation cost, the problem with the random numbers, and the problem with the floating-point errors.

In addition, to realize the finite field GF(p) in Shamir's (k, n) threshold scheme, a block length on the computer needs to be set to p bits. However, for example, because 1 byte=256 bits is not a prime, the computational efficiency is poor. However, in NPL 2, a finite field GF (q) has been generalized and improved to a secret sharing scheme on an extension field of degree m, that is, GF (q\hat{ }m), and there has been disclosed an improved technique for realizing a flexible configuration in terms of the number of managers and the implementation on a computer.

### CITATION LIST

### Non-Patent Literature

NPL1: A. Shamir, “How to share a secret, “Communication of the ACM, vol. 22, no. 11, pp. 612-613, 1979.
NPL2: E. D. Karnin, J. W. Greene, M. E. Hellman, “On Secret Sharing Systems,” IEEE Transaction on Information Theory, vol. 29, no. 1, pp. 35-41

### SUMMARY

### Technical Problem

The disclosure of each of the above NPLs is incorporated herein by reference thereto. The following analysis has been made by the present inventor.

In a broader sense, Shamir's (k, n) threshold secret sharing scheme of NPL 1 has the following three problems.

[Problem 1] There is a risk that, if an attacker wiretaps a communication immediately before a decryption apparatus, all the share data necessary for decryption could be stolen. If an attacker steals the share data necessary for decryption, the original data will be decrypted, leading to information leakage.

[Problem 2] The validity of the transmitter and receivers are not guaranteed. This is because there is no procedure for verifying that the devices transmitting and receiving share data are valid devices. While this verification method is generally referred to as authentication, NPL 1 discloses only a mechanism directed to secret sharing, and no authentication mechanism is included.

[Problem 3] There is no method for detecting inclusion of invalid share data in share data handled in a decryption process. This is because there is no function of verifying whether the share data is valid.

Problem 1 relates communication wiretapping, and there are the following two causes for problem 1.

Since the (k, n) threshold scheme disclosed in NPL 1 is a scheme in which share data used for restoration is transmitted to a single device as restorable data. Therefore, if an attacker wiretaps a communication immediately before the device that executes restoration and steals a number of share data necessary for restoration, there is a risk that the attacker can restore the original data.

Since the (k, n) threshold scheme disclosed in NPL 1 is a scheme in which, after collecting the share data used for restoration to a single device, the original data is restored. Therefore, if an attacker wiretaps a communication immediately before the device that executes restoration, all the share data necessary for restoration could be stolen.

It is an object of the present invention to provide a key delivery system, a key delivery method, and a program that improves validity verification and a share data collection method at decryption and reduces a risk for wiretapping on a communication path.

As means for solving problem 1, share data is encrypted in advance and distributed to each apparatus. Instead of collecting all the share data in a single apparatus at a single location, an interpolation method is applied in a distributed and series process based on polynomial parameters and x-coordinates obtained by an interpolation method executed in an apparatus in the previous stage, and share data of its own apparatus.

As means for solving problem 2, a verification method that can verify that each apparatus has an ability to execute secret sharing, without transmitting and receiving keys between apparatuses by distributing keys that authenticate between apparatuses in an initial phase is used.

As means for solving problem 3, a distributed and series process in finite bodies, which is executed in a decryption process, is repeatedly performed using different apparatuses each time to verify inclusion of invalid share data.

### [Operations of Means Providing Advantageous Effects]

### [Countermeasure 1: Countermeasure Against a Risk of Stealing all Share Data Necessary for Decryption by an Attacker, in Case the Attacker Wiretaps Communication Immediately Before a Decryption Apparatus, as in Problem 1]

The first countermeasure is to have the share data encrypted in advance and then distribute it to each apparatus. This makes it impossible for the attacker to decrypt the original data due to encryption, even if the share data on a communication path or an intermediate formula of an interpolation method is wiretapped. In addition, by using encryption having properties of additive homomorphism and multiplicative homomorphism, the share data is distributed to each apparatus after being encrypted in a distribution phase, the interpolation method is applied while the share data is encrypted, and decryption is executed at an end of a decryption phase.

The second countermeasure is to apply the interpolation method in the distributed and series process using a plurality of apparatuses based on polynomial parameters, x-coordinates, and share data of its own apparatus, instead of collecting all the share data in a single apparatus at a single location. The polynomial parameters and the x-coordinates are obtained by an interpolation method executed in an apparatus in the previous stage. A conventional Lagrange interpolation method requires a number k+1 of share data for a single interpolation calculation. In the present invention, the interpolation method used is changed to the Newton interpolation method. At each apparatus, interpolating polynomial parameters are obtained one by one in order from the lowest dimensional term, and the parameters and x-coordinates are transmitted and received between apparatuses to obtain a polynomial of the distribution phase.

### [Newton Interpolation]

The Newton interpolation is an interpolation method called Newton difference quotient interpolation, and indicates that when coordinates of real numbers of k+1 independent points are (a₁, f(a₁)), (a₂, f(a₂)), . . . , and (a₍ₖ₊₁₎, f(a₍ₖ₊₁₎)), then kth polynomial passing through the k+1 points can be expressed as in Equation 8.

$$f ( x ) = {c}_{0} + {c}_{1} ( x - {a}_{1} ) + {c}_{2} ( x - {a}_{1} ) ( x - {a}_{2} ) + … + {c}_{n} ( x - {a}_{1} ) ( x - {a}_{2} ) … ( x - {a}_{k} ) \qquad [ Equation 8 ]$$

Where parameters of each term in Equation 8 are difference quotients denoted by c₀=f(a₁), c₁=f(a₁, a₂), c₂=f(a₁, a₂, a₃), . . . , c₍ₖ₋₁₎=f(a₁, a₂, . . . , a₍ₖ₋₁₎), and cₖ=f(a₁, a₂, . . . , aₖ), respectively. The first-order difference quotient c1 is defined by f(a₁, a₂)=(f(a₂)−f(a₁))/(a₂−a₁), and indicates a slope of a straight line connecting the two points (a₁, f(a₁)) and (a₂, f(a₂)). The second-order difference quotient c2 is defined by Equation 9 from the first-order difference quotient c1=f(a₁, a₂)=(f(a₂)−f(a₁))/(a₂−a₁), and is a difference quotient obtained by subtracting the first-order difference quotient between a₁ and a₂ and the first-order difference quotient between a₁ and a₀.

$${c}_{2} = f ( {a}_{1} , {a}_{2} , {a}_{3} ) = ( f ( {a}_{2} , {a}_{1} ) - f ( {a}_{1} , {a}_{0} ) ) / ( {a}_{2} - {a}_{1} ) \qquad [ Equation 9 ]$$

The k-order difference quotient cₖ=f(a₁, a₂, . . . , aₖ) is defined by Equation 10, and is the difference quotient obtained by subtracting an (n−1)th-order difference quotient from a₂ to aₖ and an (n−1)th-order difference quotient from a₁ to a₍ₖ₋₁₎.

$${c}_{k} = f ( {a}_{1} , {a}_{2} , … , {a}_{k} ) = ( f ( {a}_{2} , … , {a}_{k} ) - ( f ( {a}_{1} , {a}_{2} , … , {a}_{( k - 1 )} ) ) / ( {a}_{k} - {a}_{1} ) \qquad [ Equation 10 ]$$

According to this newton difference quotient interpolation formula, it is possible to calculate the polynomial parameters c₀, c₁, . . . , and cₖ while adding a single coordinate at each point one by one, based on the definition of the difference quotient.

[Countermeasure 2: Countermeasure for Problem 2 that Validity of

Transmitter and Receiver are not Guaranteed] As a countermeasure for problem 2, a verification method that can verify that each apparatus has an ability to execute secret sharing, without transmitting and receiving keys between apparatuses by distributing keys that authenticate between apparatuses in an initial phase is used. In this scheme, one-time share data for verification, which is created based on a secret sharing scheme, is transmitted to a single apparatus, and whether an opposite apparatus transmits a response based on the secret sharing scheme is verified. By executing encryption and decryption on response data using a previously distributed verification key, the validity of each of the apparatuses can be verified.

[Countermeasure 3: Countermeasure for Problem 3 that there is No Method for Detecting Inclusion of Invalid Share Data in Share Data Handled in a Decryption Process]

As countermeasure for problem 3, a distributed and series process in finite bodies, which is executed in a decryption process, is performed multiple times using different apparatuses each time. Results of the processes are then compared to verify whether the results are always the same, thereby verifying whether invalid share data is included.

### Solution to Problem

According to a first aspect of the present invention or the disclosure, there is provided A key delivery system, including:
a key issuance apparatus that generates and issues an encryption key;
a distribution apparatus including:
a share data generation part that electronically divides the encryption key into share data using a secret sharing scheme,
a transmission destination verification part that verifies validity of a transmission destination in transmitting the share data, and
a share data transmission part that transmits the share data to the transmission destination, when a verification result obtained by the transmission destination verification part is valid; and
a decryption apparatus comprising:
a transmission source verification part that verifies validity of a transmission source, in receiving the share data,
a share data reception part that receives the share data from the transmission source when a verification result obtained by the transmission source verification part is valid, and
a decryption part that decrypts the encryption key using the share data received, as an input value.

According to a second aspect of the present invention or the disclosure, there is provided a key delivery method, including: a step of generating and issuing an encryption key;
a step of electronically dividing the encryption key into a plurality of share data using a secret sharing scheme;
a step of verifying validity of both of a delivery source and a delivery destination by executing mutual verification on both of the delivery source and the delivery destination in delivering the plurality of share data;
a step of delivering the plurality of share data; and
a step of decrypting the encryption key using the plurality of share data as an input value.

According to a third aspect of the present invention or the disclosure, there is provided a program, causing a computer to execute:
a process for generating and issuing an encryption key;
a process for electronically dividing the encryption key into a plurality of share data using a secret sharing scheme;
a process for verifying validity of both of a delivery source and a delivery destination by executing mutual verification on both of the delivery source and the delivery destination in delivering the plurality of share data;
a process for delivering the plurality of share data; and
a process for decrypting the encryption key using the plurality of share data as an input value.

### Advantageous Effects of Invention

According to the present invention or the individual disclosed aspects, the present invention provides a key delivery system, a key delivery method, and a program that improves validity verification and a share data collection method at decryption and reduces a risk for wiretapping on a communication path.

### BRIEF DESCRIPTION OF DRAWINGS

FIG. 1 is a block diagram illustrating an example of a configuration of a key delivery system according to an example embodiment.

FIG. 2 is a schematic diagram illustrating an outline of a process of a key delivery system according to a first example embodiment.

FIG. 3 is another schematic diagram illustrating the outline of the process of the key delivery system according to the first example embodiment.

FIG. 4 is a flowchart illustrating an example of a process of the key delivery system according to the example embodiment.

FIG. 5 is a block diagram illustrating an example of a system configuration of the key delivery system according to the first example embodiment.

FIG. 6 is a schematic diagram illustrating a data flow in a decryption process in the key delivery system according to the first example embodiment.

FIG. 7 is a conceptual diagram illustrating a data division method at generation of a polynomial in a distribution process in the key delivery system according to the first example embodiment.

FIG. 8 is a conceptual diagram illustrating a share data for verification creation method in a verification process in the key delivery system according to the first example embodiment.

FIG. 9 is a sequence diagram illustrating exchange between transmission apparatus and a reception apparatus in the verification process in the key delivery system according to the first example embodiment.

FIG. 10 is a schematic diagram illustrating a hardware configuration of a key delivery system that embodies the key delivery system according to the first example embodiment.

FIG. 11 is a schematic diagram illustrating a mode in a decryption process in a key delivery system according to another example embodiment of the invention.

FIG. 12 is a schematic diagram illustrating another mode in a decryption process in a key delivery system according to another example embodiment of the invention.

### EXAMPLE EMBODIMENTS

First, an outline of an example embodiment will be described. In the following outline, various components are denoted by reference numerals (or signs) for the sake of convenience. That is, the following reference numerals (or signs) are used only as examples to facilitate understanding of the present invention. Thus, the description of the outline is not intended to impose any limitations. An individual connection line between blocks in the drawings signifies both one-way and two-way directions. An arrow schematically illustrates a principal signal (data) flow and does not exclude bidirectionality. In addition, while not explicitly illustrated in the circuit diagrams, the block diagrams, the internal configuration diagrams, the connection diagrams, etc., in the disclosure of the present application, an input port and an output port exist at an input end and an output end of an individual connection line. The same holds true for the input-output interfaces.

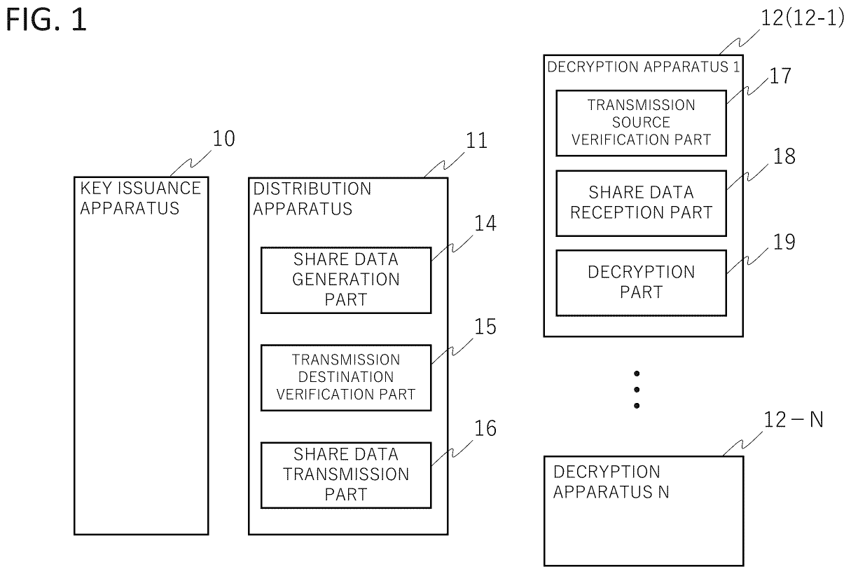

First, as an outline of an example embodiment, an example of a configuration of a key delivery system will be described with reference to a block diagram. FIG. 1 is a block diagram illustrating an example of a configuration of a key delivery system according to the example embodiment. As illustrated in this diagram, the key delivery system according to the example embodiment includes a key issuance apparatus 10, a distribution apparatus 11, and a decryption apparatus 12. The distribution apparatus 11 includes a share data generation part 14, a transmission destination verification part 15, and a share data transmission part 16. The decryption apparatus 12 includes a transmission source verification part 17, a share data reception part 18, and a decryption part 19.

While not illustrated, the distribution apparatus 11 may include the decryption part 19, and may function as a decryption apparatus at decryption.

As illustrated in FIG. 1, the key issuance apparatus 10 may be a separate apparatus from the distribution apparatus 11. Alternatively, the key issuance apparatus 10 and the distribution apparatus 11 may be integrally formed.

The key issuance apparatus 10 generates and issues an encryption key. In the distribution apparatus 11 adjacent to the key issuance apparatus 10, the share data generation part 14 electronically divides the issued encryption key into share data using a secret sharing scheme. The transmission destination verification part 15 verifies validity of a transmission destination when transmitting the generated share data. The share data transmission part 16 transmits the share data to the transmission destination, when the result of verification by the transmission destination verification part 15 is valid. In a decryption apparatus 12-1 opposite the distribution apparatus 11, the transmission source verification part 17 verifies validity of the transmission source when receiving the share data. The share data reception part 18 receives the share data from the transmission source when the result of verification by the transmission source verification part 17 is valid. The decryption part 19 decrypts the encryption key using the received share data as an input value.

There may be a plurality of decryption apparatuses 12 as illustrated in FIG. 1 (decryption apparatus 1 to decryption apparatus N). When distributing share data, the share data is transmitted from the distribution apparatus 11 to the decryption apparatuses 1 to N after mutually verifying validity of each apparatus.

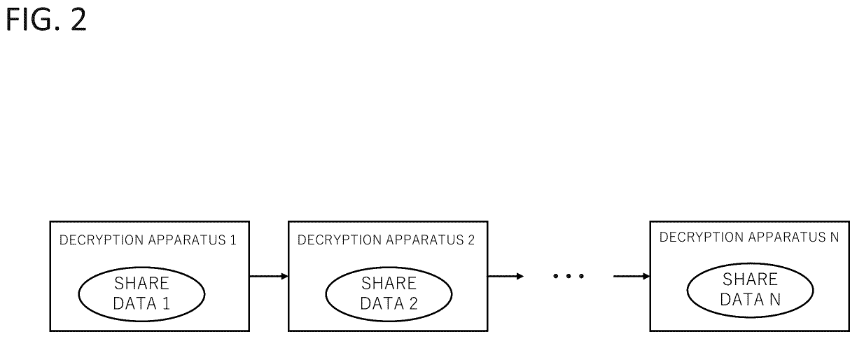

FIG. 2 is a diagram illustrating an outline of a process of the key delivery system in a decryption phase according to an example embodiment. At decryption, the decryption apparatuses 1 to N are arranged such that data flows in series, and the decryption apparatuses 1 to N execute a distributed and series process in which an arbitrary decryption apparatus serves as a start point and the share data is decrypted sequentially. In FIG. 2, the decryption process is executed sequentially from the decryption apparatus 1 holding share data 1 to the decryption apparatus N holding share data N.

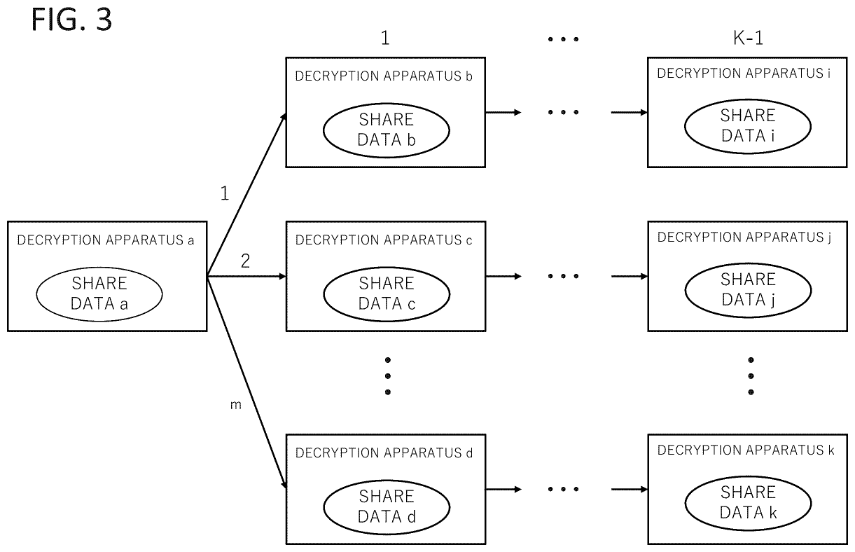

FIG. 3 is a diagram illustrating an outline of another process of the key delivery system in the decryption phase according to the example embodiment. A plurality of decryption apparatuses is divided into m groups, each of which includes a minimum number of apparatuses that can be decrypted (k apparatuses in FIG. 3). Then, each group executes the decryption process, and the decryption results are compared with each other.

### [Operation]

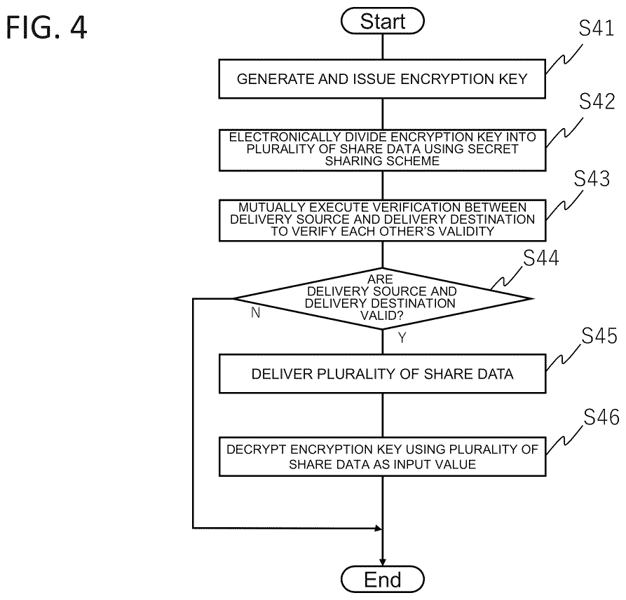

FIG. 4 is a flowchart illustrating an example of an operation of the key delivery system according to the example embodiment. As illustrated in this flowchart, first, an encryption key is generated and issued (step S41). Next, the encryption key is electronically divided into a plurality of share data using a secret sharing scheme (step S42). Next, a delivery source and a delivery destination mutually execute verification, so as to verify each other's validity (step S43). As a result of the verification, if either the delivery source or the delivery destination is invalid, the process ends (N in step S44). If both of the delivery source and the delivery destination are valid (Y in step S44), the delivery source delivers a plurality of share data (step S45). At decryption, the delivery destination decrypts the encryption key using the delivered plurality of share data as an input value (step S46).

When share data is distributed, the distribution apparatus and the decryption apparatus mutually verify each other's validity. This prevents the share data from being stolen by disguising or impersonating some apparatuses. In addition, the share data is distributed and processed in series to avoid concentrating all the share data in a single apparatus. This prevents invalid decryption of key data or stealing of key data. Furthermore, the decryption process is repeated in a plurality of groups of decryption apparatuses. This makes it possible to detect an inclusion of invalid share data in a decryption apparatus.

Hereinafter, concrete example embodiments will be described in more detail with reference to drawings. The same components in the individual example embodiments will be denoted by the same reference numerals (or signs), and redundant description thereof will be omitted.

### First Example Embodiment

In the mode of a system according to a first example embodiment, although a distribution apparatus installed in series to a key issuance apparatus mainly serves as a share data transmitter because of its physical configuration, the share data transmitter and the share data receivers have the same internal configuration and functions. Thus, hereinafter, these apparatuses will be referred to as distribution-decryption apparatuses, and the following description assumes that these apparatuses switch their roles, depending on a process request or a setting from the outside.

### [Premise]

It is assumed that the distribution and decryption are performed on an extension field GF (2\hat{ }8). The extension field is an algebraic system including {0, 1, . . . 255}, and operation results thereof are also represented by {0, 1, . . . , 255}. The reason for the assumption is to take into account floating points and carryover due to a four arithmetic operation when executing the interpolation method, as well as to consider performance on a computer.

### [Information Previously Distributed to and Set in Apparatuses]

In order to execute the (k, n) threshold secret sharing scheme, the numbers k and n are previously defined and set in the entire system. n is the number of distribution-decryption apparatuses that transmit and receive share data one time of distribution in the system. k is the minimum number of share data required when decrypting an original data. The relationship between the numbers n and k satisfies n>k.

Two kinds of homomorphic encryption keys, which are an encryption key and a verification key, are used for data encryption. The encryption key above is different from the encryption key distributed in advance for delivery of share data, and is the key used to execute data encryption of share data. The verification key is used to encrypt data for verification. The encryption key and verification key are distributed in advance to all the distribution-decryption apparatuses. As the encryption scheme, a public key encryption scheme that enables both of additive homomorphic encryption and multiplicative homomorphic encryption is used so that addition and multiplication can be executed on encrypted data. One reason for use of homomorphic encryption is that, by executing interpolation on encrypted share data, data, including such as intermediate results in the decryption process, can be kept secret.

### [Configuration]

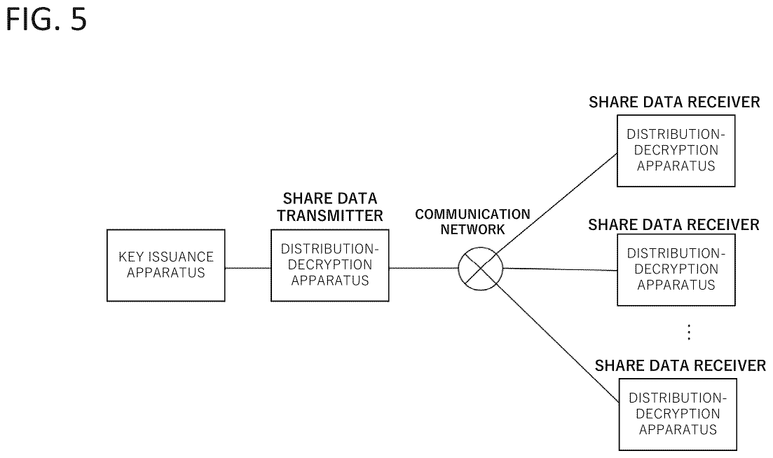

As illustrated in FIG. 5, the example embodiment of the present invention includes a key issuance apparatus and a plurality of distribution-decryption apparatuses. The key issuance apparatus is connected in series to one of the distribution-decryption apparatuses. This distribution-decryption apparatus is connected to the other distribution-decryption apparatuses via a communication network. Because the distribution-decryption apparatus connected in series to the key issuance apparatus operates as a function (hereinafter referred to as a roll) of transmitting share data at distribution, this distribution-decryption apparatus will be referred to as a share data transmitter. In contrast, because the other distribution-decryption apparatuses beyond the communication network have a roll of receiving the transmitted share data, these distribution-decryption apparatuses will be referred to as share data receivers.

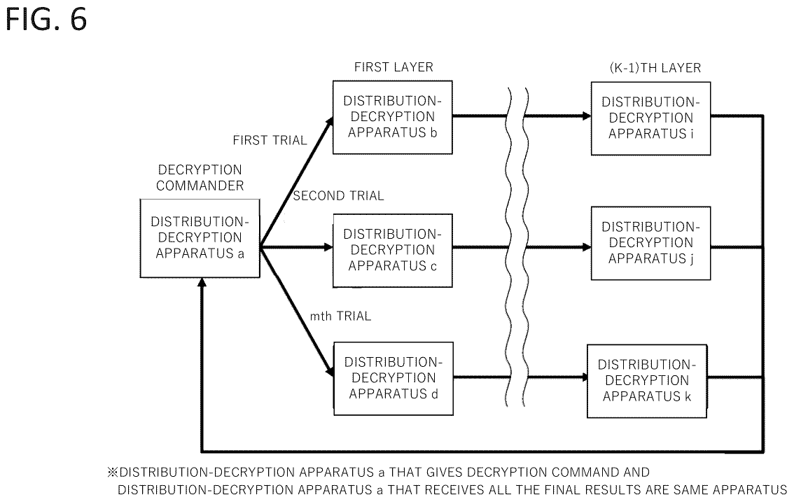

As illustrated in FIG. 6, data flow in the distributed and series process in the decryption phase according to the present invention indicates that decryption is executed by executing a distributed and series process in which an arbitrary distribution-decryption apparatus serves as the start point and a plurality of distribution-decryption apparatuses process in series. Herein, because the distribution-decryption apparatus serving as the start point has a roll of commanding the decryption process, this distribution-decryption apparatus will be referred to as decryption commander.

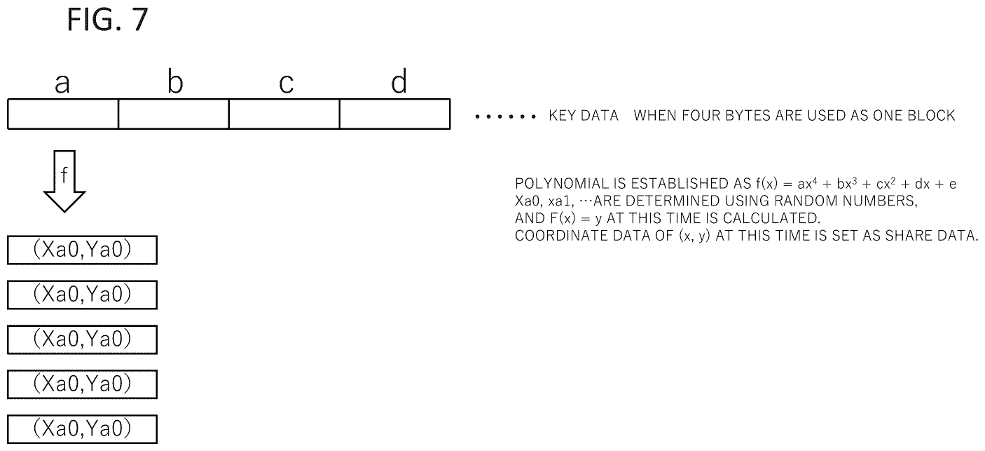

The operation in the distribution phase according to the present invention is executed by causing the distribution-decryption apparatus adjacent to the key issuance apparatus illustrated in FIG. 5 to convert an issued key into a distributed share data. As illustrated in FIG. 7, in the distributed and series process in the distribution phase according to the present invention, the decryption commander divides original data byte by byte and allocates the divided data as polynomial parameters for each term, except an intercept of polynomial. In the example in FIG. 7, the divided original data is allocated to the four bytes of parameters a, b, c, and d of a fourth-degree polynomial, respectively, in order.

In the conventional Shamir's (k,n) threshold secret sharing scheme, in which an intercept is original data s, f(0)=s is directly calculated by Lagrange interpolation method. In a case of a method in which only the intercept of the polynomial is original data, the original data may be predictable by approximation and interpolation methods if a plurality of share data is stolen. In addition, in Shamir's (k, n) threshold scheme, because a single original data is allocated to the intercept, only one parameter can be obtained per calculation.

In the key delivery system according to the present example embodiment, a plurality of divided original data is allocated to parameters of each term of a polynomial, rather than to an intercept of the polynomial. Thus, because the number of the divided original data obtained in one calculation is increased many times, the compression efficiency can be improved (in the example in FIG. 7, the four points of a, b, c, and d are used, which is four times the conventional original data amount). At decryption, by obtaining an original polynomial from each coordinate using an interpolation method, the parameters of each term of the polynomial are acquired, and the original data is decrypted.

In the key delivery system according to the present example embodiment, the compression efficiency of the original data obtained in one calculation depends on a value of k in the (k, n) threshold scheme. A recommended value for k in the best mode will be defined as follows.

Regarding the value for k, that is, the degree of the polynomial, even when an impact of an error by the finite field is not considered, a higher degree results in a greater calculation cost. For example, if Newton interpolation is executed with the following coordinates, the following four arithmetic operations are executed.

Newton interpolation at five points need 10 divisions, 20 subtractions, 4 multiplications, and 8 additions.

Newton interpolation at 10 points need 45 divisions, 90 subtractions, 9 multiplications, and 18 additions.

Newton interpolation at 15 points need 105 divisions, 210 subtractions, 14 multiplications, and 28 additions.

Newton interpolation at 20 points need 190 divisions, 380 subtractions, 19 multiplications, and 38 additions.

In addition, when interpolation is executed with GF (2\hat{ }8), while the additions and multiplications are executed with exclusive-OR XOR, the multiplications and divisions are processed by table lookups using an operation table. If the number of divisions that increases exponentially is taken into consideration, a recommended value for k is up to 20.

The operation in the verification phase in the key delivery system according to the present example embodiment is carried out by the distribution-decryption apparatus adjacent to the key issuance apparatus illustrated in FIG. 5 transmitting the share data created in the distribution phase to another distribution-decryption apparatus installed at an opposite site after mutually verifying the validity of each apparatus. In the verification, the distribution-decryption apparatus as a share data transmitter creates share data for verification, both of the share data transmitter and a share data receiver mutually verify validity of each apparatus by calculating certain coordinates from a polynomial that both of the share data transmitter and the share data receiver have obtained. Upon completion of the verification, the share data transmitter transmits share data created in the distribution phase to the share data receiver at the opposite site.

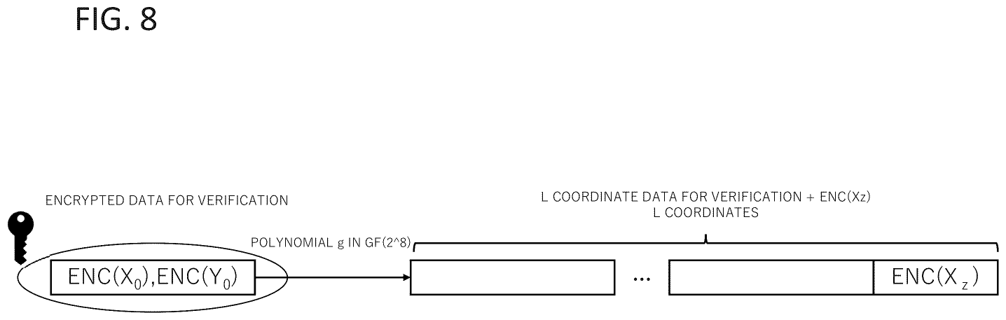

Referring to FIG. 8, in a verification data creation process in the verification phase in the key delivery system according to the present example embodiment, after creating data for verification (coordinate data) encrypted with the verification key, the decryption commander creates a 1th-degree polynomial g, whose intercept is the data for verification ENC(Y0), and L coordinates of coordinate data for verification that go through the polynomial.

Because of the above-described problem with the calculation amount, it is desirable that the degree 1 of the polynomial be up to 20 points (k=20). The parameters of each term other than the intercept of the polynomial are determined by random numbers based on an arbitrary method. The number L of the coordinate data for verification is to be equal to or greater than 1+1 from the degree of the polynomial.

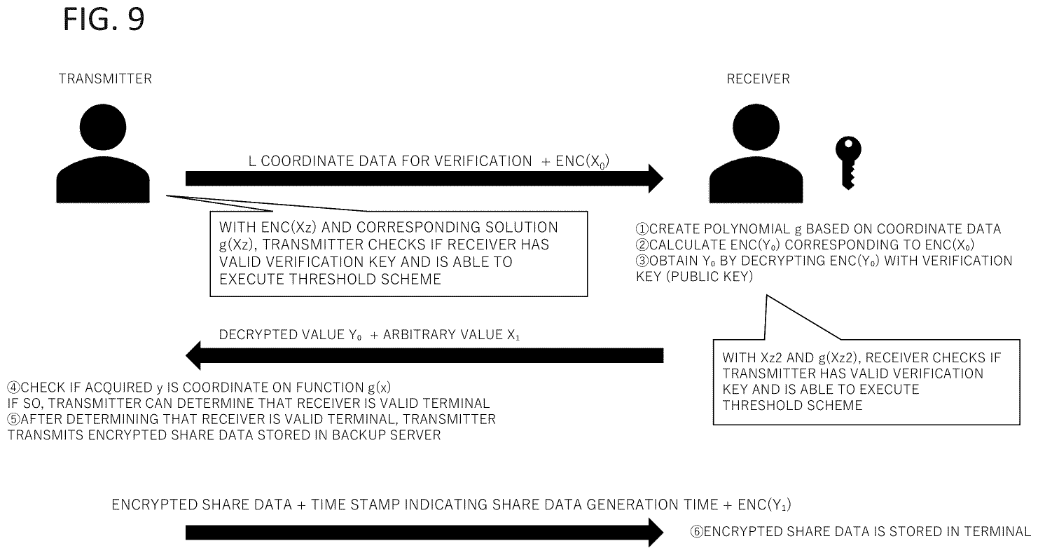

FIG. 9 illustrates a process flow after transmitting L coordinate data for verification and an encrypted x-coordinate ENC(x0) to a opposite apparatus, when mutually verifying validity of each apparatus, in the verification phase in the key delivery system according to the present example embodiment. In accordance with procedure 1 to 3 in FIG. 9, the receiver creates, based on an interpolation polynomial g′ obtained from the coordinate data for verification and a verification key distributed in advance, a Y coordinate y₀ corresponding to ENC(x₀), and an arbitrary value x₁, and presents thereof to the transmitter to show the validity of the receiver. The transmitter confirms whether g(x₀), which is obtained based on the polynomial g and the verification key distributed in advance, matches y₀ to verify the validity of the receiver.

In accordance with procedure 4 and 5 in FIG. 9, the transmitter presents a value ENC(y₁) obtained by encrypting the Y coordinate corresponding to the X coordinate x₁, which is transmitted from the receiver, to show the validity of the transmitter. Simultaneously, the transmitter also distributes the encrypted share data generated in the distribution phase and a time stamp indicating the share data generation time. The receiver determines whether g(x₁), which is created from the interpolation polynomial obtained from the coordinate data for verification, matches y₁ to verify the validity of the transmitter.

In the operation in the decryption phase according to the present invention, a distributed and series process is executed in which, of all the distribution-decryption apparatuses including the share data transmitter and the share data receivers illustrated in FIG. 5, an arbitrary one (decryption commander) of the distribution-decryption apparatuses is used as a start point and cooperates with a plurality of other distribution-decryption apparatuses.

As illustrated in FIG. 6, the distributed and series process in the decryption phase in the key delivery system according to the present example embodiment is performed as follows. A decryption commander serving as the start point gives a decryption command to its subsequent apparatuses. Each distribution-decryption apparatus in a first layer calculates a parameter c₀ of an interpolation polynomial of Newton interpolation using one share data distributed to the distribution-decryption apparatus and transmits an x coordinate of the share data and c₀ to its subsequent apparatus, and each subsequent apparatus in each subsequent layer repeats this process. Then, each distribution-decryption apparatus in the subsequent (k−1)th layer calculates a difference quotient in the same way and transmits the x coordinates of the share data held by the distribution-decryption apparatuses in the 1st to (k−1)th layers and the difference quotients of c₀, c₁, . . . , and c₍ₖ₋₂₎ to the decryption commander. The decryption commander calculates, based on the transmitted information and the share data held thereby, c₍ₖ₋₁₎ by itself, expands equations, and obtains the original polynomial in the distribution phase and parameters of each term of the polynomial.

In addition, as illustrated in FIG. 6, the distributed and series process in the decryption phase in the key delivery system according to the present example embodiment is repeatedly executed on a plurality of paths on the data flow beginning with the decryption commander, which serves as the start point, (each distributed and series process will hereinafter be referred to as a trial) and verifies whether or not invalid share data is introduced during the distributed and series process by comparing the trial results with each other.

The number m of trials is limited to up to 12. The reason for this is that if redundancy of share data, that is, redundancy of the apparatuses holding share data, is not allowed and the maximum value of k in the (k, n) threshold scheme is set to 20, the maximum number of share data is to be 256 {0, 1, 2, 3, . . . , 255} due to GF (2\hat{ }8), i.e., the number of apparatuses holding the share data is 256, and then 256−20=12 with a remainder of 16.

As another desirable mode of the invention, an existing security technique may be additionally used to ensure security. For example, the present scheme does not include measures against a case in which a communication message is falsified on a communication path in the distribution process. A desirable mode can be achieved by additionally using known techniques, which are, for example, encrypted communications such as TLS (Transport Layer Security) communication or IPsec (Security Architecture for Internet Protocol), measures for prevention of falsification of communication messages based on digital signatures, and security fortification of the apparatuses.

### [Hardware Configuration]

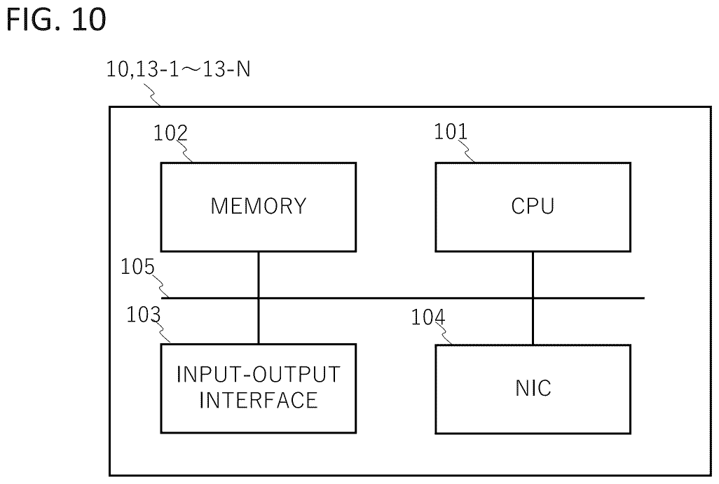

The key delivery system according to the present example embodiment can be executed by an information processing apparatus (a computer). The key issuance apparatus 10 and a plurality of distribution-decryption apparatuses 13-1 to 13-N constituting the system has a configuration illustrated as an example in FIG. 10. The key issuance apparatus 10 and the distribution-decryption apparatuses 13-1 to 13-N each include, for example, a CPU (central processing unit) 101, a memory 102, an input-output interface 103, and a NIC (network interface card) 104, which is communication means. These components are connected to each other via an internal bus 105.

The hardware configuration of the key delivery system is not limited to the configuration illustrated in FIG. 10. The key issuance apparatus 10 and the distribution-decryption apparatuses 13-1 to 13-N may include hardware not illustrated or may be configured without the input-output interface 103 as appropriate. In addition, for example, the number of CPUs included in each of these apparatuses is not limited to the example illustrated in FIG. 10. For example, a plurality of CPUs may be included in each of the key issuance apparatus 10 and the distribution-decryption apparatuses 13-1 to 13-N.

The memory 102 is a RAM (random access memory), a ROM (read-only memory), or an auxiliary storage device (a hard disk, for example).

The input-output interface 103 is means serving as an interface for a display device or an input device not illustrated. The display device is, for example, a liquid crystal display or the like. The input device is, for example, a device such as a keyboard or a mouse that receives user operations.

Functions of the key issuance apparatus 10 and the distribution-decryption apparatuses 13-1 to 13-N are realized by a group of programs (processing modules) such as a key issuance program, a share data generation program, a verification program, a delivery program, and a decryption program stored in the memory 102, and a group of data such parameters used by the individual programs. The processing as modules are realized when the CPU 101 executes the individual programs stored in the memory 102, for example. In addition, each program can be updated by downloading a program update via a network or using a storage medium storing a program update. In addition, the processing modules may be realized by semiconductor chips. That is, the key issuance apparatus 10 and the distribution-decryption apparatuses 13-1 to 13-N have means for executing the functions of the above-described processing modules based on hardware or software.

### [Hardware Operation]

### [Distribution Phase]

First, in the key issuance apparatus 10, the key issuance program is invoked from the memory 102 and is executed by the CPU 101. This program generates an encryption key in accordance with a predetermined key issuance algorithm, and outputs and issues the encryption key to the distribution-decryption apparatuses 13-1 to 13-N. Next, for example, in the distribution-decryption apparatus 13-1, the share data generation program is invoked from the memory 102 and becomes executable by the CPU 101. This program divides the issued encryption key, allocates the divided data to parameters other than an intercept of the polynomial, and temporarily stores the data in the memory 102.

Next, in the distribution-decryption apparatus 13-1, the verification program is invoked from the memory 102, and becomes executable by the CPU 101. This program creates data for verification (coordinate data) (ENC(X₀), ENC(Y₀)) encrypted with a previously generated verification key stored in the memory 102, generates an 1th-degree polynomial g using ENC(Y₀) as the intercept and L verification coordinate data on the polynomial, and ENC(X₀), and transmits them to another distribution-decryption apparatus, e.g., the distribution-decryption apparatus 13-2, via the NIC 104.

In the distribution-decryption apparatus 13-2, the verification program is invoked from the memory 102, and becomes executable by the CPU 101. This program calculates an expression g from the L coordinate data, and calculates ENC(Y₀) from ENC(X₀). Next, the program decrypts Y₀ with the verification key previously distributed and stored in the memory 102. Next, the program transmits Y₀ and arbitrary X₁ to the distribution-decryption apparatus 13-1 via the NIC 104. The verification program in the distribution-decryption apparatus 13-1 receives the data, assigns X₀ to g stored in the memory 102, and checks if a result obtained by assignment matches the received Y₀.

If the result matches Y₀, the verification program in the distribution-decryption apparatus 13-1 calculates a value ENC(Y₁) obtained by encrypting the Y coordinate corresponding to the X coordinate X₁ transmitted from the verification program in the distribution-decryption apparatus 13-2. The verification program in the distribution-decryption apparatus 13-2 determines whether g (X₁) created from the interpolation polynomial obtained from the coordinate data for verification matches Y₁. At this point, simultaneously, the delivery program is invoked from the memory 102 and is executed by the CPU 101, and the encrypted share data generated in the distribution phase and a share data generation time timestamp are delivered to the distribution-decryption apparatus 13-2 via the NIC 104. The distribution-decryption apparatus 13-2 stores these delivered data in the memory 102.

### [Decryption Phase]

In the decryption phase, one of the distribution-decryption apparatus 13-1 to 13-N executes a decryption process as a decryption commander which serves as the start point. The following description assumes, as an example, a process in which the distribution-decryption apparatus 13-2 is used as the start point (the end point) and five share data (N=5) are generated (that is, the distribution-decryption apparatuses 13-1 to 13-5 are present). In the distribution-decryption apparatus 13-2, when the decryption program is invoked from the memory 102, and becomes executable by the CPU 101, the operation based on the Newton interpolation method is executed using the share data stored in the memory 102. As a result, first, a parameter c₀ of the interpolation polynomial is calculated. The calculated c₀ is transmitted, along with the x coordinate of the share data, for example, to the distribution-decryption apparatus 13-3 via the NIC 104. In the distribution-decryption apparatus 13-3, the decryption program, which has become executable by the CPU 101, receives c₀, and calculates a difference quotient c₁. In the distribution-decryption apparatuses 13-4 and 13-5, the verification program repeats this calculation. As a result, difference quotients c₂ and c₃ are calculated and transmitted to the distribution-decryption apparatus 13-2 serving as the start point via the NIC 104. In the distribution-decryption apparatus 13-2, the decryption program receives these data via the NIC 104, and the CPU 101 calculates c₄ from the received c₀ to c₃ and the share data. This program expands equations using c₀ to c₄ and the share data, and acquires the original 3rd-degree polynomial and the parameters of each term of the polynomial.

In this way, this program can decrypt the encryption key, which is the secret information, from the parameters.

### Advantageous Effects

As described above; by adopting a verification process based on a threshold scheme in the distribution phase, it is possible to verify that the transmitter and receiver have necessary capabilities for the system and they hold a verification key that no third party knows. In this way, an apparatus disguised and impersonated by an attacker can be determined, and the validity of the data, and the validity of the transmitter and receiver can be checked.

In addition, the distributed and series process in the decryption phase can prevent a single apparatus from collecting all the share data. Although there is a possibility that information on a calculation process can be stolen by wiretapping on a communication path, stealing of the share data by the decryption commander can be prevented, thus reducing a risk of decryption or stealing of the key data by an attacker.

In addition, in the decryption process, decryption is executed on different groups of share data, and results obtained thereby are compared with each other. For example, by adopting the most common result, even when invalid share data is included in the decryption phase, the inclusion of the invalid share data can be detected.

### Other Example Embodiments of Invention

### [Another Mode 1: Decryption Process Based on Tree Structure]

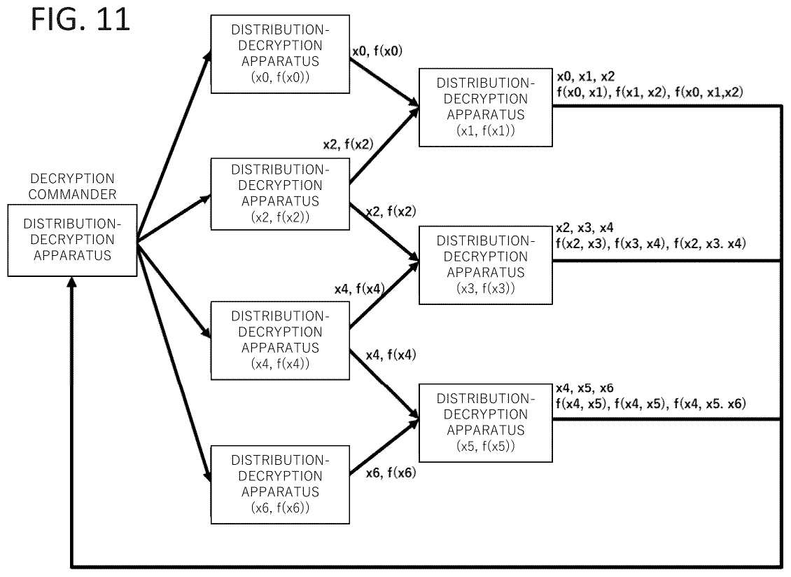

FIG. 11 illustrates a data flow in which k=7. This data flow is obtained by improving the data flow illustrated in FIG. 6 to a tree-type data flow. In a single distributed and series process executed by the decryption commander in FIG. 6 in the decryption phase according to the present invention, a data flow of a single column is executed.

In FIG. 11, the decryption commander transmits a decryption command to four apparatuses in the first stage. Each distribution-decryption apparatus in the first stage transmits its own share data to an apparatus in the second stage. Each of the three apparatuses in the second stage calculates a difference quotient using its own share data and the share data transmitted from the first stage as input information, and transmits a calculation result to the decryption commander. The decryption commander creates a final Newton interpolation polynomial using the difference quotients transmitted from the three apparatuses in the second stage, an x coordinate, and its own share data as its input.

The scheme illustrated in FIG. 11 reduces the network delay compared with the case in which apparatuses are connected in series with each other as illustrated in FIG. 6. On the other hand, because the apparatuses in the first stage and the apparatuses in the second stage transmit and receive share data, the risk that arises when communication wiretapping or compromise of encryption occurs is more significant than that in FIG. 6. Thus, use of the scheme in FIG. 11 is premised on a closed network other than a public network.

### [Another Mode 2: Distribution Process Using Reducible Polynomial and Decryption Process Based on Tree-Type Structure]

When a polynomial is used with k=10 to 20, a better efficiency can be achieved, for example, by defining the polynomial in the distribution phase in the form of a reducible polynomial expressed by f(x)·h(x)· . . . in advance. The reducible polynomial means a factorable polynomial, and is a polynomial expressed by a product of a plurality of polynomials.

For example, if Newton interpolation is executed on a 19th-degree polynomial (k=20),
because Newton interpolation is executed at 20 points, 190 divisions, 380 subtractions, 19 multiplications, and 38 additions are needed.

However, in the case of a reducible polynomial including two 9^{th}-degree polynomials,
because Newton interpolation is executed at 10 points, 45×2 divisions, 90×2 subtractions, 9×2 multiplications, and 18×2 additions are needed.

By expressing a polynomial using a product of low-degree original polynomials based on factorization in advance, the calculation amount can be reduced.

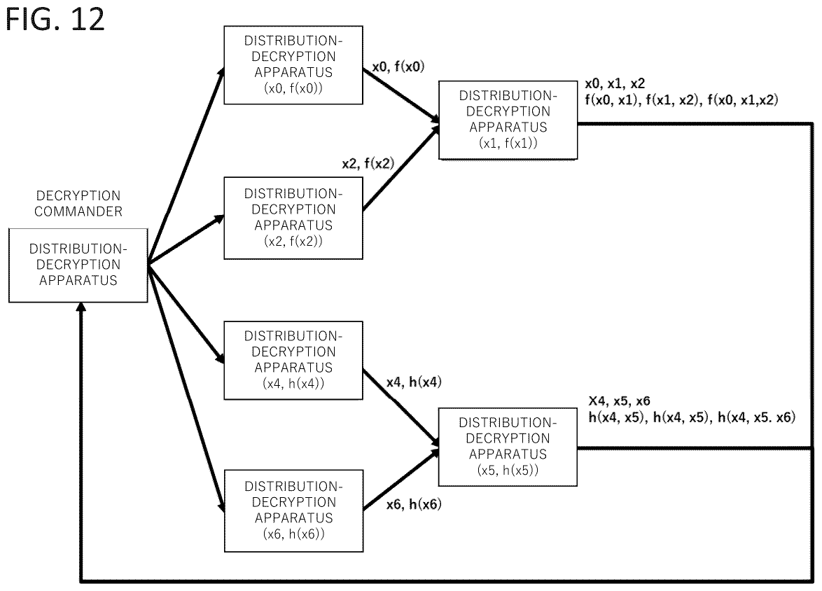

FIG. 12 illustrates a data flow executed when a reducible polynomial including two polynomials is used in the distributed and series process in the decryption phase according to the present invention. In the polynomial, the apparatuses holding the share data based on f(x) belong to the upper group in FIG. 12, and the apparatuses holding the share data based on g(x) [sic. h(x)] belong to the lower group in FIG. 12. Each polynomial configures a data flow with a tree structure and calculates a difference quotient. Then, the decryption commander finally calculates the original f(x)×g(x) [sic. h(x)].

As is the case with FIG. 11, the scheme illustrated in FIG. 12 reduces a network delay compared with the case in which apparatuses are connected in series with each other as illustrated in FIG. 6. On the other hand, because the apparatuses in the first stage and the apparatuses in the second stage transmit and receive share data, the risk that arises when communication wiretapping or compromise of encryption occurs is more significant than that in FIG. 6. Thus, use of the scheme in FIG. 12 is premised on a closed network other than a public network.

### [Another Mode 3: Distribution Process and Decryption Process Using Portable Storage Medium]

The configurations illustrated in FIGS. 5 and 6 as example embodiments of the present invention include a network. However, in mode 3, instead of a network, a portable storage medium such as a USB memory, a CD, or a DVD is used to transmit and receive data.

As illustrated in FIG. 5, an example embodiment of the present invention includes a key issuance apparatus and a plurality of distribution-decryption apparatuses. The key issuance apparatus is connected in series to a single distribution-decryption apparatus, which is connected to the other distribution-decryption apparatuses via a communication network.

Mode 3 is based on the configuration in FIG. 5, and the data flow based on the network connecting the distribution-decryption apparatuses is replaced by a data flow based on a portable storage medium (hereinafter referred to as “air gap”).

In mode 3, in the distribution phase, share data and a tool for verification are stored in a portable storage medium as a carried and transported, and the share data and the tool for verification are stored in a distribution-decryption apparatus at an opposite site. In the verification phase in mode 3, the portable storage medium is connected to the distribution-decryption apparatus at the opposite site, the tools for verification is executed, the sequence illustrated in FIG. 9 is executed between the portable storage medium and the connected distribution-decryption apparatus, the validity of the portable storage medium and the validity of the connected distribution-decryption apparatus are mutually verified, and the share data is distributed to the connected distribution-decryption apparatus.

In addition, in the decryption phase in mode 3, an original polynomial is obtained by connecting a portable storage medium to a distribution-decryption apparatus, requesting the distribution-decryption apparatus to execute a decryption process via a tool for verification, storing a calculation result of distributed and series process executed and responded to by the distribution-decryption apparatus, repeatedly executing the same, and executing a final calculation by a distribution-decryption apparatus serving as the decryption commander.

The portable storage medium stores a tool for verification that is used for mutually verifying a control terminal and the portable storage medium connected to each other. In the verification phase and the decryption phase, after the sequence illustrated in FIG. 9 is executed by executing the tool for verification, distribution of the share data and a request to calculate the distributed and series process are performed.

In mode 3, the system agent executing the verification tool may be, for example, the portable storage medium as an embedded apparatus including a storage area and an SoC. In this case, the SoC may serve as a main agent and may execute the tool for verification. Alternatively, the portable storage medium may be configured without an SoC or a control part, and the control terminal to which the portable storage medium is connected may serve as a main agent and executes the verification tool. Mode 3 is directed to both of the cases. The control terminal in the latter case may be embedded in the distribution-decryption apparatus or may be disposed at a location away from and adjacent to the distribution-decryption apparatus. Mode 3 is directed to both of the cases.

The above example embodiments can be entirely or partially described as the following notes. However, the following notes are simply examples of the present invention, and therefore, the present invention is not limited to these examples.

### [Note 1]

See the key delivery system according to the above first aspect.

### [Note 2]

In the key delivery system described in Note 1, it is preferable that the share data generation part in the distribution apparatus
uses an integer n of 2 or greater and an integer threshold k between 2 and n, inclusive, the threshold k being a minimum number necessary for reconstructing the encryption key, as preset values,
creates a (k−1)th-degree polynomial in which the encryption key is allocated to polynomial parameters of each term other than an intercept using a (k−1) byte as a block length according to the (k−1)th-degree polynomial in an extension field, and
converts the encryption key into k coordinates or more on a curve of the polynomial so as to generate the share data.

### [Note 3]

In the key delivery system described in Note 2; it is preferable that the decryption part in the decryption apparatus decrypts the encryption key by acquiring a Newton interpolation polynomial, which is acquired by calculating a difference quotient using k share data one by one as an input value to acquire a polynomial used when dividing the encryption key electronically.

### [Note 4]

In the key delivery system described in any one of Notes 1 to 3; it is preferable that, when the transmission destination verification part in the distribution apparatus verifies validity of the transmission destination and the transmission source verification part in the decryption apparatus verifies validity of the transmission source, the transmission destination verification part and the transmission source verification part verify both of the transmission source and the transmission destination have secret sharing capabilities and have a verification key previously distributed using data presented for verification.

### [Note 5]

In the key delivery system described in Note 4; it is preferable that each of the transmission destination verification part in the distribution apparatus and the transmission source verification part in the decryption apparatus creates a response to one-time message created each of the transmission source and the transmission destination, respectively, and verifies respective validity of both the transmission source and the transmission destination, based on the secret sharing scheme.

### [Note 6]

The key delivery system described in any one of Notes 1 to 5, preferably further includes a plurality of decryption apparatuses.

Each of the plurality of decryption apparatuses corresponds to the decryption apparatus, and
each of the plurality of decryption apparatuses is connected in series, and sequentially decrypt share data.

### [Note 7]

In the key delivery system described in Note 6; it is preferable that the plurality of decryption apparatuses executes an operation for decrypting an encryption key a plurality of times from each of a plurality of groups of share data including different share data, so as to verify validity of the share data.

### [Note 8]

In the key delivery system described in Note 6 or 7; it is preferable that the plurality of decryption apparatuses decrypts the encryption key by executing a plurality of decryption processes in series and in a distributed manner and executing the decryption processes repeatedly.

### [Note 9]

See the key delivery method according to the above second aspect.

### [Note 10]

See the program according to the above third aspect.

### [Note 11]

The key delivery system described in any one of Notes 6 to 8 preferable includes
a plurality of decryption apparatuses.

Each of the plurality of decryption apparatuses corresponds to the decryption apparatus, and
one decryption apparatus among the plurality of decryption apparatuses is connected to another decryption apparatus in a one-to-many relationship and executes a decryption process by distributed process executed by a plurality of apparatuses configured in a tree structure to decrypt the encryption key.

### [Note 12]

In the key delivery system described in Note 2, it is preferable that the share data generation part replaces the polynomial of a secret sharing method with a reducible polynomial that is expressed in advance as a product of a plurality of polynomials according to the factor theorem.

### [Note 13]

In the key delivery system described in any one of Notes 6 to 8, it is preferable that a distribution apparatus and decryption apparatuses disposed at a plurality of spatially different locations transmit and receive data using a portable storage medium.

### [Note 14]

The key delivery system described in Note 1 preferably delivers the share data and a program for causing a computer to execute a process for verifying validity of both of a delivery destination and a delivery source, by storing thereof on a portable storage medium and transporting them from one distribution apparatus or decryption apparatus to another decryption apparatus.

### [Note 15]

The key delivery system described in Note 14, preferably executes the program stored in the portable storage medium to perform verification between the program and the distribution apparatus or the decryption apparatus in accordance with the verification process described in Note 4 or Note 5.

### [Note 16]

The key delivery system described in Note 14 or 15, preferably includes a method in which the share data and the program are stored in the portable storage medium, the portable storage medium is transported to another decryption apparatus, and decryption is executed in accordance with the decryption method based on the secret sharing scheme described in Note 3.

### [Note 17]

The key delivery system described in Note 1, preferably includes a method in which the share data is encrypted with homomorphic encryption having properties of additive homomorphism and multiplicative homomorphism, and decryption is executed at the end of a decryption process.

The disclosure of each of the above NPLs is incorporated herein by reference thereto. Modifications and adjustments of the example embodiments or examples are possible within the scope of the overall disclosure (including the claims) of the present invention and based on the basic technical concept of the present invention. Various combinations or selections (including partial deletion) of various disclosed elements (including the elements in each of the claims, example embodiments, examples, drawings, etc.) are possible within the scope of the disclosure of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

10: key issuance apparatus
11: distribution apparatus
12, 12-1 to 12-N: decryption apparatus
13-1 to 13-N: distribution-decryption apparatus
14: share data generation part
15: transmission destination verification part
16: share data transmission part
17: transmission source verification part
18: share data reception part
19: decryption part
101: CPU
102: memory
103: input-output interface
104: NIC
105: internal bus

What is claimed is:

1. A key delivery system, comprising:
a key issuance apparatus that generates and issues an encryption key;
a distribution apparatus comprising:
at least a processor; and
a memory in circuit communication with the processor,
wherein the processor is configured to execute program instructions stored in the memory to implement:
a share data generation part that electronically divides the encryption key into share data using a secret sharing scheme,
a transmission destination verification part that verifies validity of a transmission destination in transmitting the share data, and
a share data transmission part that transmits the share data to the transmission destination, when a verification result obtained by the transmission destination verification part is valid; and
a decryption apparatus comprising:
at least a processor; and
a memory in circuit communication with the processor,
wherein the processor is configured to execute program instructions stored in the memory to implement:
a transmission source verification part that verifies validity of a transmission source, in receiving the share data,
a share data reception part that receives the share data from the transmission source when a verification result obtained by the transmission source verification part is valid, and
a decryption part that decrypts the encryption key using the share data received, as an input value.

2. The key delivery system according to claim 1; wherein
the share data generation part in the distribution apparatus
uses an integer n of 2 or greater and an integer threshold k between 2 and n, inclusive, the threshold k being a minimum number necessary for reconstructing the encryption key, as preset values,
creates a (k−1)th-degree polynomial in which the encryption key is allocated to polynomial parameters of each term other than an intercept using a (k−1) byte as a block length according to the (k−1)th-degree polynomial in an extension field, and
converts the encryption key into k coordinates or more on a curve of the polynomial so as to generate the share data.

3. The key delivery system according to claim 2; wherein
the decryption part in the decryption apparatus decrypts the encryption key by acquiring a Newton interpolation polynomial, which is acquired by calculating a difference quotient using k share data one by one as an input value to acquire a polynomial used when dividing the encryption key electronically.

4. The key delivery system according to claim 1; wherein
when the transmission destination verification part in the distribution apparatus verifies validity of the transmission destination and the transmission source verification part in the decryption apparatus verifies validity of the transmission source,
the transmission destination verification part and the transmission source verification part verify both of the transmission source and the transmission destination have secret sharing capabilities and have a verification key previously distributed using data presented for verification.

5. The key delivery system according to claim 4; wherein
each of the transmission destination verification part in the distribution apparatus and the transmission source verification part in the decryption apparatus creates a response to one-time message created each of the transmission source and the transmission destination, respectively, and verifies respective validity of both the transmission source and the transmission destination, based on the secret sharing scheme.

6. The key delivery system according to claim 1, comprising
a plurality of decryption apparatuses, wherein
each of the plurality of decryption apparatuses corresponds to the decryption apparatus, and
each of the plurality of decryption apparatuses is connected in series, and sequentially decrypt share data.

7. The key delivery system according to claim 6; wherein
the plurality of decryption apparatuses executes an operation for decrypting an encryption key a plurality of times from each of a plurality of groups of share data including different share data, so as to verify validity of the share data.

8. The key delivery system according to claim 6; wherein
the plurality of decryption apparatuses decrypts the encryption key by executing a plurality of decryption processes in series and in a distributed manner and executing the decryption processes repeatedly.

9. A key delivery method, comprising:
generating and issuing an encryption key;
electronically dividing the encryption key into a plurality of share data using a secret sharing scheme;
verifying validity of both of a delivery source and a delivery destination by executing mutual verification on both of the delivery source and the delivery destination in delivering the plurality of share data;
delivering the plurality of share data; and
decrypting the encryption key using the plurality of share data as an input value.

10. A non-transitory computer-readable medium storing a program, causing a computer to execute:
a process for generating and issuing an encryption key;
a process for electronically dividing the encryption key into a plurality of share data using a secret sharing scheme;
a process for verifying validity of both of a delivery source and a delivery destination by executing mutual verification on both of the delivery source and the delivery destination in delivering the plurality of share data;
a process for delivering the plurality of share data; and
a process for decrypting the encryption key using the plurality of share data as an input value.

11. The key delivery system according to claim 2; wherein
when the transmission destination verification part in the distribution apparatus verifies validity of the transmission destination and the transmission source verification part in the decryption apparatus verifies validity of the transmission source,
the transmission destination verification part and the transmission source verification part verify both of the transmission source and the transmission destination have secret sharing capabilities and have a verification key previously distributed using data presented for verification.

12. The key delivery system according to claim 3; wherein
when the transmission destination verification part in the distribution apparatus verifies validity of the transmission destination and the transmission source verification part in the decryption apparatus verifies validity of the transmission source,
the transmission destination verification part and the transmission source verification part verify both of the transmission source and the transmission destination have secret sharing capabilities and have a verification key previously distributed using data presented for verification.

13. The key delivery system according to claim 2, comprising
a plurality of decryption apparatuses, wherein
each of the plurality of decryption apparatuses corresponds to the decryption apparatus, and
each of the plurality of decryption apparatuses is connected in series, and sequentially decrypt share data.

14. The key delivery system according to claim 3, comprising
a plurality of decryption apparatuses, wherein
each of the plurality of decryption apparatuses corresponds to the decryption apparatus, and
each of the plurality of decryption apparatuses is connected in series, and sequentially decrypt share data.

15. The key delivery system according to claim 4, comprising
a plurality of decryption apparatuses, wherein
each of the plurality of decryption apparatuses corresponds to the decryption apparatus, and
each of the plurality of decryption apparatuses is connected in series, and sequentially decrypt share data.

16. The key delivery system according to claim 5, comprising
a plurality of decryption apparatuses, wherein
each of the plurality of decryption apparatuses corresponds to the decryption apparatus, and
each of the plurality of decryption apparatuses is connected in series, and sequentially decrypt share data.

17. The key delivery system according to claim 7; wherein
the plurality of decryption apparatuses decrypts the encryption key by executing a plurality of decryption processes in series and in a distributed manner and executing the decryption processes repeatedly.

18. The key delivery method according to claim 9, wherein:
the share data is generated by
using an integer n of 2 or greater and an integer threshold k between 2 and n, inclusive, the threshold k being a minimum number necessary for reconstructing the encryption key, as preset values,
creating a (k−1)th-degree polynomial in which the encryption key is allocated to polynomial parameters of each term other than an intercept using a (k−1) byte as a block length according to the (k−1)th-degree polynomial in an extension field, and
converting the encryption key into k coordinates or more on a curve of the polynomial.

19. The key delivery method according to claim 18, wherein:
the encryption key is decrypted by acquiring a Newton interpolation polynomial, which is acquired by calculating a difference quotient using k share data one by one as an input value, to acquire a polynomial used when dividing the encryption key electronically.

20. The key delivery method according to claim 9, wherein:
when verifying validity of both of a delivery source and a delivery destination, verifying both of the delivery source and the delivery destination have secret sharing capabilities and have a verification key previously distributed using data presented for verification.
